(19) United States
(12) Patent Application Publication
(10) Pub. No.: US 2011/0191796 A1
(43) Pub. Date: Aug. 4, 2011

(54) Media Player-Based Authentication

(75) Inventors: Sailendra K. Padala, San Mateo, CA (US); Emma Wei, Cupertino, CA (US)

(73) Assignee: CBS Interactive, Inc., San Francisco, CA (US)

(21) Appl. No.: 13/018,205

(22) Filed: Jan. 31, 2011

Related U.S. Application Data
(60) Provisional application No. 61/299,518, filed on Jan. 29, 2010.
(60) Provisional application No. 61/312,226, filed on Mar. 9, 2010.

(51) Int. Cl. H04N 7/16

(52) U.S. Cl. 725/25

(57) ABSTRACT

Computer-implemented method, computer program products and systems for authenticating a user to view content from at least one domain as authorized for viewing by a Multichannel Video Programming Distributor (MVPD). Receiving an MVPD identification. Loading and launching a client executable MVPD authentication application specific to the identified MVPD. Authenticating the user for viewing content from a first domain with the identified MVPD using the MVPD authentication application. In some embodiments receiving a first content identifier associated with the first domain of the MVPD, and authenticating the user's access to the identified content from the first domain. In some embodiments receiving a content identifier associated with a second domain associated with the identified MVPD, and playing the content associated with the second domain based on the authentication, and the association of the second domain with the MVPD, without further authentication.

### CROSS REFERENCE TO RELATED APPLICATIONS

This application claims the benefit of U.S. Provisional Patent Application No. 61/299,518, filed Jan. 29, 2010, and U.S. Provisional Patent Application No. 61/312,226, filed Mar. 9, 2010.

### FIELD

The technology disclosed herein (the “technology”) generally relates to digital rights management. Exemplary implementations relate to managing access to streaming media across service providers (SPs), e.g., content owner/content aggregator Internet sites, where some SPs have a common distribution channel.

### BRIEF DESCRIPTION OF THE DRAWINGS

Reference will now be made, by way of example, to the accompanying drawings which show example implementations of the technology.

FIG. 1 illustrates systems of the present technology.

FIG. 2 illustrates a user interface of the present technology.

FIG. 3 illustrates methods of the present technology

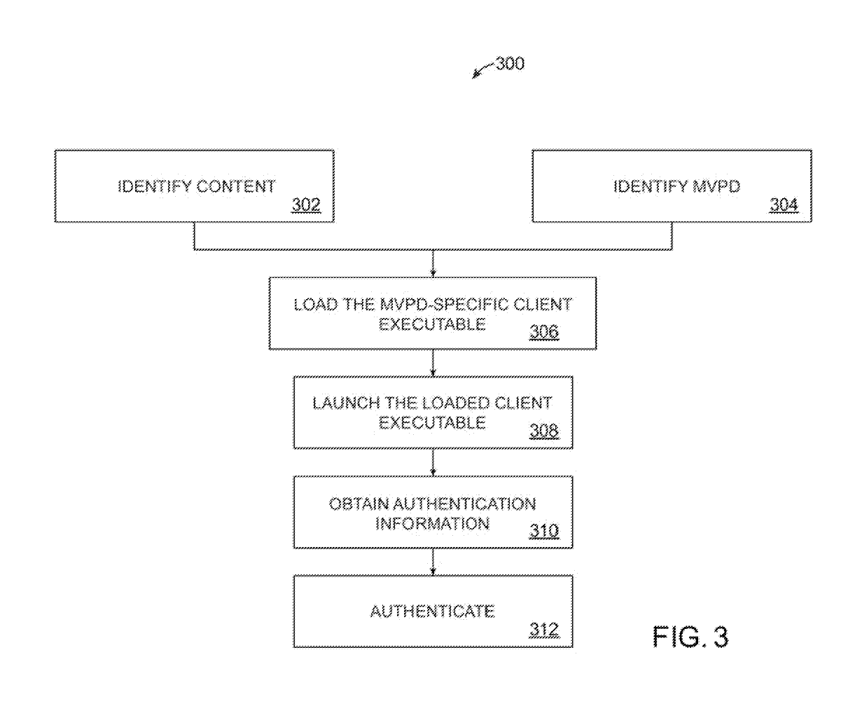

### DETAILED DESCRIPTION

Reference now will be made in detail to implementations of the technology. Each example is provided by way of explanation of the technology only, not as a limitation of the technology. It will be apparent to those skilled in the art that various modifications and variations can be made in the present technology without departing from the scope or spirit of the technology. For instance, features described as part of one implementation can be used on another implementation to yield a still further implementation. Thus, it is intended that the present technology cover such modifications and variations that come within the scope of the technology.

Currently, most television content is provided through a Multiple System Operator (MSO). An MSO is an operator of multiple cable television systems. Examples of MSOs are Time Warner Cable®, Cablevision™, Comcast® and Cox Communications® in the US, Rogers Communications and Shaw Communications in Canada or Virgin Media in the UK. Typically, MSOs provide content on a subscription basis. In other words, subscribers pay a periodic fee for a bundle of content channels. A “set-top box” is coupled to the television set and provides security, through an authentication mechanism and/or decryption capabilities, to attempt to ensure that only subscribers gain access to the content. As used herein, “MSO” includes any system broadcasting content from multiple content providers (e.g., broadcast networks), even non-cable systems and single system broadcasters.

In this conventional arrangement, the content only can be viewed at the television coupled to the set top box, which is in turn coupled directly to the cable system. The recent popularity of computers and portable computing devices, such as smartphones, laptops, netbooks, and tablets, has spawned demand for watching television content on portable devices, e.g., using video players of various types such as native video players and browser-embedded video players.

Web based distributors, such as Hulu® and YouTube®, provide various content over the Internet. However, because of established licensing and revenue models, very little television content is available over the Internet leaving users tied to their home television to watch such content. Hulu and YouTube do not authenticate users as valid customers of an MSO. As such, even if a user is not a customer of an MSO carrying the content, the user may view the content, providing video content to users for free. As a result, many television content providers have refused to provide access to their content through Hulu or YouTube.

More recently, specific MSOs have begun to provide mechanisms for authenticating users, verifying if they have a subscription, and allowing the user to watch subscription content on devices other than their home television. The availability of content distribution to multiple devices increases concerns about fraudulent access to unauthorized content. Some current MSO authentication systems require authentication of the user device and verification that the user is in fact a subscriber. Known systems for such authentication are cumbersome to the user. Users have to go to multiple pages that have an inconsistent look and feel to be authenticated. In addition, there is need to enable more efficient and effective ways to identify the appropriate MSO for authentication, in particular, for mobile devices that may not be set up or operating under the control of a particular MSO. For example, if a user requests proprietary content from a web site, e.g., http:/www.cbs.com, they may be authenticated for the content before being permitted to access the content. If the same user navigates to a different domain, e.g., http://www.sho.com (a web site for Showtime® entertainment services) the user will have to be authenticated again, requiring the user to enter a password, present a token, or the like. Further known systems are difficult to implement and integrate into the MSO distribution system.

MSOs can be seen as a subset of Multichannel Video Programming Distributors (MVPDs). An MVPD is a service provider delivering video programming services, usually for a subscription fee (pay TV). These operators include cable television (CATV) systems, direct-broadcast satellite (DBS) providers, and wireline video providers including Verizon FiOS as well as AT&T U-verse and competitive local exchange carriers (CLECs) using IPTV. Section 602 (13) of The Communications Act of 1934 (as amended by the Telecommunications Act of 1996) defines an MVPD as a person such as, but not limited to, a cable operator, a multichannel multi-point distribution service, a direct broadcast satellite service, or a television receive-only satellite program distributor, who makes available for purchase, by subscribers or customers, multiple channels of video programming. This disclosure uses the term MVPD to include MSOs.

Embodiments of the technology include systems in which the authentication mechanism is embedded in a media player. Such embodiments include MVPD-specific interfaces, allowing an MVPD to integrate into player-based authentication. The user authentication can be persistent across domains. For example, upon authentication of a user as having access to an MVPD from a device, the MVPD can load a cookie in the device's browser through the interface for authentication, and as the user navigates the Internet among domains of SPs carried by the MVPD to which the user subscribes.

Other approaches, e.g., website-based domain-by-domain authentication and site-by-site player driven login, present disadvantages. For website-based authentication, e.g., login to a site, the user experience is typically characterized by multiple pages and inconsistent look and feel across domains. With regard to user tracking and security, website-based authentication presents cross domain issues, and the user information (Universal Unique ID and tokens) are exposed to content owner/content aggregator—a.k.a. the Service Provider (SP). For video distribution and security, such authentication does not stick to embeds, complicating distribution. The approach presents scalability and performance issues in that it involves more integration points; and both the MVPD's & SP's infrastructure involved, raising costs for each. Typical implementations involve a rigid protocol, e.g., Security Assertion Markup Language (SAML) and complex implementation for the SP. For player driven login on the site, the challenges are similar, except that video distribution and security can be more readily handled.

In some embodiments of the present technology, including direct player-based login to an MVPD as an identity provider (IdP), the user experience can be improved by combining login on the same video page as the player. The MVPD can control user tracking across domains, e.g., from http://www.cbs.com to http://www.sho.com where the user has a subscription to both CBS and Showtime on the MVPD. Video distribution and security can be improved, in part because authentication can stick with embeds, for example, the requirement of authentication sticks with embeds of the video (via links) in other pages. This approach can present less integration points, lower infrastructure challenges, and can allow MVPDs to use more efficient and flexible proprietary protocols.

Player-based MVPD authentication can provide a better user experience and a consistent look and feel. With player-based authentication, an MVPD can control user tracking across domains. Further player-based authentication can provide more secure and simpler means for implementation and distribution.

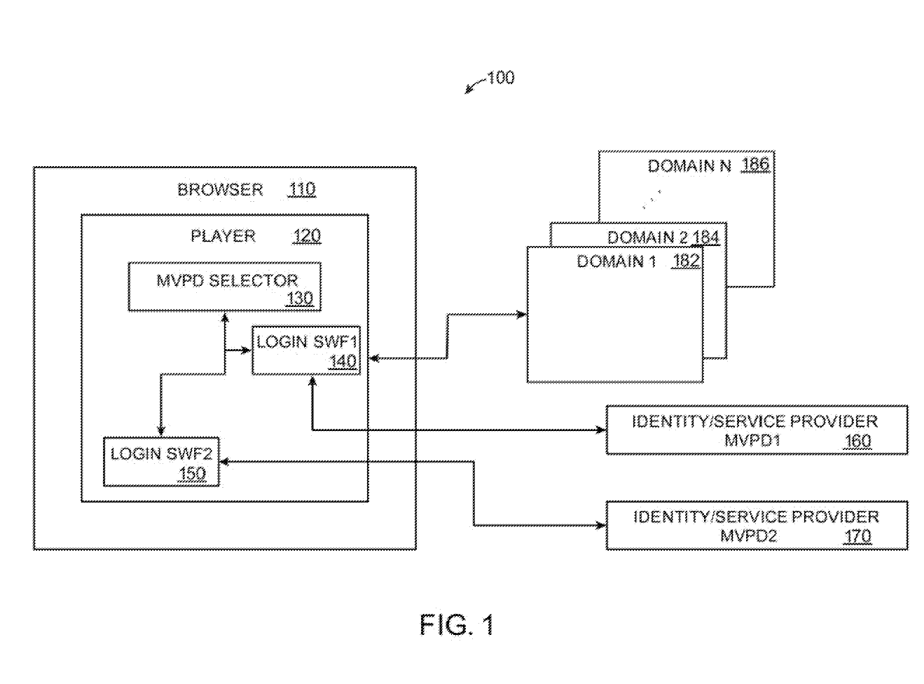

FIG. 1 is a block diagram of an example embodiment of the technology. A media player 120 can be instantiated in a browser 110. However, the player 120 also can be invoked outside of a browser (e.g., as a native application, as part of the core function of the device). The way in which the player 120 is invoked can depend on the device, for example, a mobile device may have the media player as a core application in the device. It will be appreciated that the media player 120 can be embeddable.

The media player 120 can include a rendering engine for rendering content into a displayable form. For example, the content can be a video stream of television content, e.g., from any one of Domain 1 182, Domain 2 184, through Domain N 186. The content can be any type of content and can include interactive ads. The media player 120 can include a selector module 130 with a user interface that can permit a user to specify an MVPD to which the user subscribes, e.g., MVPD1 160, MVPD2 170. For example, a user may subscribe to MVPD1 160, which may offer content from Domain 1 182 and Domain 2 184.

Each MVPD can provide an interface for authentication in the form of a client executable program, such as a SWF file or the like, e.g., Login SWF1 140, Login SWF2 150. The SWF file format can deliver vector graphics, text, video, and sound over the Internet and is supported by various media players, such as Adobe® Flash® Player and Adobe Air™ software. Each interface can be customized for content from a corresponding MVPD, for example the MVPD can include additional functionality in the interface, such as prompting an non-subscriber to sign up for a subscription. The MVPD selector 130 in some embodiments includes an application programming interface (API) that calls the client executable program corresponding to the selected MVPD, e.g., Login SWF1 140 for MVPD1 160, Login SWF1 150 for MVPD2 170. The client executable program, e.g., SWF file, then provides the MVPD specific protocols for authentication with the specified MVPD.

Typically, a media player is configured to work as a client application where a party that controls the server controls access to online content. The player can be a client based application to render the digital media but interfaces with the server for information on where to obtain content, control over content transfer and use (e.g. allow technical control over rights granted for use of the content), and to collect user data associated with content (or advertising) displayed, user interaction (e.g. starts, stops, clicks on content etc.) use and/or interaction with the user to invoke other content/features. The general interaction between a client player and the server is well known.

The player 120 can run on various hardware devices. The interfaces can be provided as client executable programs, e.g., SWF files, or through other mechanisms. Any media player can be used. The embodiment can be applied to television content streamed over the Internet or to other content over other transmission mechanisms.

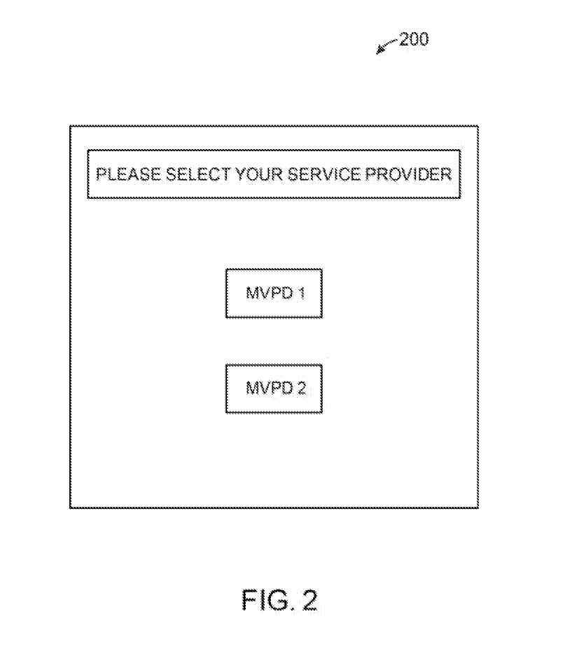

With reference to FIG. 2, in an example embodiment employing a browser 110 with a player 120, e.g., an Adobe Flash player, a user identifies content to render (e.g., a video to view) 302 using the player. Identification of the content can be in any manner, such as browsing a web site or a content catalog. For example, the user can navigate the browser 110 to www.cbs.com and select a television program to watch by clicking on an icon or other standard user interface mechanism. In another example, the user can select the content from within the media player.

The appropriate MVPD can be identified 304. Various methods can be used to identify the appropriate MVPD, for example, a user's MVPD can be identified through a browser cookie, a flash cookie, or some identifier/token on the device. The appropriate MVPD can be inferred by checking the predominant location of a device over a period of time, e.g., the device is predominantly located in the coverage area of the MVPD, infer from the user's Internet Service Provider (ISP) (which can be the user's MVPD.

As further examples, the appropriate MVPD can be selected by user input through a user interface of the device; from an MVPD registration system, e.g., the user is registered on an MVPD/distributor site and the player is launched from the MVPD/distributor site; from a cookie/token on the device; from an IP address; based on behavioral data, e.g. that the user is always looking at San Francisco restaurants, may indicate their location; based on location information from a mobile device, such as current or common GPS information; based on a previously stored IdP preference stored on a common domain; and from an aggregation service, such as a social network, that provides an ID aggregator.

FIG. 2 illustrates a screen shot of a possible user interface that can be used to select the MVPD/distributor. Upon making a content selection, as described above, the user is presented with the screen shown in FIG. 2 which provides the user with, in this example, a choice of three distributors to choose from. The list of distributors can be narrowed or created based on the techniques noted above. For example, we might know for the IP address that the user is in San Francisco and the user interface might provide the user with a selection of the most likely distributors in San Francisco.

The player 120 can load the client executable program 306, e.g., Login SWF1 140 for identified MVPD1 160, and the client executable program, e.g., SWF file, initiates an API defining the communication between the player and the MVPD interface—including the information that may be passed, including the content identifier the user has selected. For example, in response to receiving user input selecting MVPD1, the MVPD Selector 130 invokes Login SWF1 140 for MVPD1. It will be appreciated that the client executable program may be remotely downloaded by the player and executed by the browser or may be embedded in the player.

An advantage of this approach is that the SP may prepare the API layer within the player 120 and the MVPD, e.g., MVPD1 may prepare a specific client executable program, e.g., Login SWF1 140, for the player. Rather than the SP preparing a unique process for each MVPD, each MVPD prepares a client executable, e.g., Login SWF2 150, for the player 120.

Once the appropriate MVPD is identified, the player 120, through the defined API, launches the appropriate client executable 308. A SWF applet is also called a ShockWave Flash file. Essentially, once invoked, the player 120 can run the interface, e.g., 140, as an application within the player.

Once the MVPD client executable program is launched, it then authenticates the user with the MVPD 310. Authentication can include authentication of the user/requested content combination with the MVPD, e.g., for MVPD1, the Identity Provider MVPD1 160. During authentication, the client executable can: check for the presence of an authentication cookie/token; invoke a viewer login request, e.g., if there is no active authentication cookie token; pass the user credentials to the IdP; if authenticated, initiate an authorization request including the content identifier passed by the player 120 API, and place an authentication cookie/token on the users system; if authorized, provides an authorization message back to the player 120 API, and place an authorization cookie/token on the users system (in part so that in case the video stream in interrupted, it can resume without reauthorization); passes control back to the player 120 to render the content (e.g., play the video)

In some embodiments, authentication processes 312 can be performed by the MVPD (e.g., via the MVPD-provided Login SWF on the device) and authorization can be performed by the Service Provider server.

It should be noted that the player is illustrated and discussed herein as having various modules which perform particular functions and interact with one another. It should be understood that these modules are merely segregated based on their function for the sake of description and represent computer hardware and/or executable software code which is stored on a computer readable medium for execution on appropriate computing hardware. The various functions of the different modules and units can be combined or segregated as hardware and/or software stored on a computer-readable medium as above as modules in any manner, and can be used separately or in combination.

It should be understood that processes and techniques described herein are not inherently related to any particular apparatus and may be implemented by any suitable combination of components.

Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive.

Those skilled in the art will appreciate that many different combinations of hardware, software, and firmware will be suitable for practicing the present invention. The computer devices can be PCs, handsets, PDAs, Internet-enabled televisions, smart phones or any other device or combination of devices which can carry out the disclosed functions in response to computer readable instructions recorded on media. The phrase “computer system”, as used herein, therefore refers to any such device or combination of such devices.

The present technology can take the forms of hardware, software or both hardware and software elements. In some implementations, the technology is implemented in software, which includes but is not limited to firmware, resident software, microcode, a Field Programmable Gate Array (FPGA), graphics processing unit (GPU), or Application-Specific Integrated Circuit (ASIC), etc. In particular, for real-time or near real-time use, an FPGA or GPU implementation would be desirable.

Furthermore, portions of the present technology can take the form of a computer program product comprising program modules accessible from computer-usable or computer-readable medium storing program code for use by or in connection with one or more computers, processors, or instruction execution system. For the purposes of this description, a computer-usable or computer readable medium can be any apparatus that can contain, store, communicate, propagate, or transport the program for use by or in connection with the instruction execution system, apparatus, or device. The medium can be non-transitory (e.g., an electronic, magnetic, optical, electromagnetic, infrared, or semiconductor system (or apparatus or device)) or transitory (e.g., a propagation medium). Examples of a non-transitory computer-readable medium include a semi-conductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD. Both processors and program code for implementing each as aspect of the technology can be centralized or distributed (or a combination thereof) as known to those skilled in the art.

Referring to FIG. 5, a data processing system (e.g., 500) suitable for storing a computer program product of the present technology and for executing the program code of the computer program product can include at least one processor (e.g., processor resources 512) coupled directly or indirectly to memory elements through a system bus (e.g., 518 comprising data bus 518a, address bus 518b, and control bus 518c). The memory elements can include local memory (e.g., 516) employed during actual execution of the program code, bulk storage (e.g., 560), and cache memories (e.g., including cache memory as part of local memory or integrated into processor resources) that provide temporary storage of at least some program code in order to reduce the number of times code must be retrieved from bulk storage during execution. Input/output or I/O devices (including but not limited to keyboards 550, displays 530, pointing devices 520, etc.) can be coupled to the system either directly or through intervening I/O controllers (e.g., 514). Network adapters can also be coupled to the system to enable the data processing control-system to become coupled to other data processing systems or remote printers or storage devices through intervening private or public networks. Modems, cable modem and Ethernet cards are just a few of the currently available types of network adapters. Such systems can be centralized or distributed, e.g., in peer-to-peer and client/server configurations. In some implementations, the data processing system is implemented using one or both of FPGAs and ASICs.

1. A computer-implemented method for authenticating a user to view content from at least one domain as authorized for viewing by an Multichannel Video Programming Distributor (MVPD); the method comprising:
in a media player executing on a client:
receiving an MVPD identification;
loading and launching a client executable MVPD authentication application specific to the identified MVPD; and
authenticating the user for viewing content from a first domain with the identified MVPD using the MVPD authentication application.

2. The method of claim 1:
further comprising, in the media player executing on the client:
receiving a first content identifier associated with the first domain of the MVPD; and
wherein authenticating the user further comprises authorizing the user's access to the identified content from the first domain.

3. The method of claim 2 further comprising, after authenticating the user:
receiving a content identifier associated with a second domain associated with the authenticated MVPD; and
playing the content associated with the second domain based on the authentication, and the association of the second domain with the MVPD, without further authentication.

4. The method of claim 1:
further comprising, in the media player executing on the client,
receiving a first content identifier associated with the first domain of the MVPD; and
after the authentication, playing the identified content.

5. The method of claim 4 further comprising, after authenticating the user:
receiving a content identifier associated with a second domain associated with the identified MVPD; and
playing the content associated with the second domain based on the authentication, and the association of the second domain with the MVPD, without further authentication.

6. The method of claim 1 wherein:
the media player is a web-based flash player, and
the MVPD authentication application is a ShockWave Flash (SWF) file.

7. A computer program product for authenticating a user to view content from at least one domain as authorized for viewing by an Multichannel Video Programming Distributor (MVPD); the computer program product comprising:
a non-transitory computer-readable medium encoded with instructions that when executed by processor resources:
receives an MVPD identification;
loads and launches a client executable MVPD authentication application specific to the identified MVPD; and
authenticates the user for viewing content from a first domain with the identified MVPD using the MVPD authentication application.

8. The computer program product of claim 7:
further comprising, in the media player executing on the client:
receiving a first content identifier associated with the first domain of the MVPD; and
wherein authenticating the user further comprises authenticating the user's access to the identified content from the first domain.

9. The computer program product of claim 8 further comprising, after authenticating the user:
receiving a content identifier associated with a second domain associated with the identified MVPD; and
playing the content associated with the second domain based on the authentication, and the association of the second domain with the MVPD, without further authentication.

10. The computer program product of claim 7:
further comprising, in the media player executing on the client,
receiving a first content identifier associated with the first domain of the MVPD; and
after the authentication, playing the identified content.

11. The computer program product of claim 10 further comprising, after authenticating the user:
receiving a content identifier associated with a second domain associated with the identified MVPD; and
playing the content associated with the second domain based on the authentication, and the association of the second domain with the MVPD, without further authentication.

12. The computer program product of claim 7 wherein:
the media player is a web-based flash player, and
the MVPD authentication application is a ShockWave Flash (SWF) file.

13. A system for authenticating a user to view content from at least one domain as authorized for viewing by an Multichannel Video Programming Distributor (MVPD); the system comprising:
processor resources;
a non-transitory computer-readable medium:
in communication with processor resources, and
encoded with instructions that when executed by a processor:
receives an MVPD identification;
loads and launches a client executable MVPD authentication application specific to the identified MVPD; and
authenticates the user for viewing content from a first domain with the identified MVPD using the MVPD authentication application.

14. The system of claim 13:
further comprising, in the media player executing on the client:
receiving a first content identifier associated with the first domain of the MVPD; and
wherein authenticating the user further comprises authenticating the user's access to the identified content from the first domain.

15. The system of claim 14 further comprising, after authenticating the user:
receiving a content identifier associated with a second domain associated with the identified MVPD; and
playing the content associated with the second domain based on the authentication, and the association of the second domain with the MVPD, without further authentication.

16. The system of claim 13:
further comprising, in the media player executing on the client,
receiving a first content identifier associated with the first domain of the MVPD; and
after the authentication, playing the identified content.

17. The system of claim 16 further comprising, after authenticating the user:
receiving a content identifier associated with a second domain associated with the identified MVPD; and
playing the content associated with the second domain based on the authentication, and the association of the second domain with the MVPD, without further authentication.

18. The system of claim 13 wherein:
the media player is a web-based flash player, and
the MVPD authentication application is a ShockWave Flash (SWF) file.
